(19) United States
(12) Patent Application Publication
(10) Pub. No.: US 2003/0132845 A1
(43) Pub. Date: Jul. 17, 2003

(54) Battery recharger for personnel locating system badges

(76) Inventor: Paul J. McDaniel III, Holly Springs, NC (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/339,812

(22) Filed: Jan. 10, 2003

Related U.S. Application Data
(60) Provisional application No. 60/347,717, filed on Jan. 11, 2002.

(51) Int. Cl. G08B 13/14

(52) U.S. Cl. 340/572.1; 340/693.1

(57) ABSTRACT

A receptacle for recharging batteries of badges in a personnel locating system and indicating the “on-duty” or “off-duty” status of individuals associated with the badges includes a battery charger and a reader. When a badge is coupled to the receptacle, the battery charger charges the rechargeable battery of the badge and the reader receives an identification signal from a transmitter in the badge. When the receptacle reads the identification signal, the receptacle may indicate that the individual monitored by the personnel locating system is off-duty. The receptacle may be coupled to a monitor to display the “on-duty” or “off-duty” status of personnel. The receptacle may further include a charge sensor for indicating the charging status of the rechargeable battery of the badge, and indicating the inability of the charger to charge the rechargeable battery.

### RELATED APPLICATIONS

This application claims the benefit of U.S. Provisional Patent Application Ser. No. 60/347,717, filed Jan. 11, 2002, the disclosure of which is hereby expressly incorporated herein by reference.

### FIELD OF THE INVENTION

The present invention generally relates to personnel locating systems and more specifically to a receptacle for use in a personnel locating system to recharge rechargeable batteries of the system badges when the badges are placed in the receptacle, thereby also indicating that the individuals associated with the badges are off-duty or no longer in the area.

### BACKGROUND OF THE INVENTION

Certain facilities, such as hospitals and other health care facilities, employ personnel locating systems for tracking the locations of doctors, nurses, and other health care providers. Many such systems include a plurality of badges, worn by the facility personnel, which transmit unique identification signals to receivers placed at various locations throughout the facility. Each receiver receives such signals only from badges in physical proximity to the receiver. The receivers transmit these signals to a central monitor or computer system that determines the locations of personnel associated with the badges based on the identification signals.

Generally, such locating systems provide an indication of the location of the personnel, but do not indicate the on-duty or off-duty status of individuals that cannot be located. When an individual is near a receiver, it may be assumed that the individual is on-duty. At times, however, individuals may leave the facility while still on-duty or enter areas of the facility that are not covered by a receiver. In these situations, not only is the locating system unable to provide the present location of the individual, it is also not possible to assume that the individual is on-duty or off-duty.

Known locating systems are further deficient in that they fail to adequately address the need for a reliable, environmentally-friendly power source for the badge transmitters (i.e., the circuitry that transmits the identification signal to the facility receivers). Some badges are powered by non-rechargeable, disposable batteries. Increasing awareness of the environmental effects of discarded disposable batteries, however, has resulted in an effort to reduce the quantity of batteries delivered to landfills and other disposal locations. In fact, European Union regulations specifically dictate to manufacturers the need to reduce the volume of materials that enter the waste stream. Consequently, for applications where a relatively large quantity of batteries is needed, such as personnel locating systems for large facilities, rechargeable batteries are desirable.

Rechargeable batteries, however, must be periodically recharged. Thus, a significant issue associated with the use of rechargeable batteries is the failure of users to recharge the batteries. In personnel locating systems, low badge battery power may render the badge transmitter inoperable, thus making it impossible for the system to locate the individual wearing the badge.

### SUMMARY OF THE INVENTION

The present invention provides a receptacle for use with a personnel locating system for recharging the badge batteries and determining whether individuals are off-duty or on-duty. The receptacle includes a battery charger and a reader. When a badge is inserted into the receptacle, the charger charges the badge battery, and the reader reads the identification signal from the badge transmitter. The receptacle may be coupled to a monitor that displays the on-duty or off-duty status of the individual associated with the badge. If the receptacle indicates that the individual's badge is located in the receptacle, the monitor indicates that the individual is off-duty. If the receptacle indicates that the individual's badge is out of the receptacle (i.e., in use), the monitor indicates that the individual is on-duty. Thus, when an individual's present location is not known because the individual is out of the range of the facility receivers, the individual's on-duty status may still be determined using the present system.

In one embodiment of the invention, the receptacle provides an “off-duty” signal to the monitor when the receptacle reader reads the badge identification signal. The monitor responds to the “off-duty” signal by displaying a message indicating that the individual associated with the badge is presently “off-duty.” The receptacle may further provide a time stamp along with the “off-duty” signal to indicate the date and time the individual placed the badge into the receptacle, thus entering “off-duty” status. This time stamp may be provided to other payroll or accounting systems, for example, and used to track the working hours of the individual. As such, the receptacle may effectively serve as a time clock, thereby encouraging individuals to use the receptacle regularly (thus, charging the badge battery) to ensure that their hours are accurately logged.

In another embodiment of the invention, the receptacle includes a charge sensor for measuring the charge of the badge battery received by the receptacle. The sensor generates a “charging” signal for a predetermined period of time while the badge is in the receptacle and the battery is being recharged. If, after a predetermined period of charging time, the sensor indicates that the value of the battery charge is less than a threshold value, the sensor generates a “cannot charge” signal to indicate that the receptacle is unable to properly charge the badge.

These and other features of the present invention will become more apparent and the invention will be better understood upon review of the following description of embodiments of the invention and the accompanying drawings.

### BRIEF DESCRIPTION OF THE DRAWINGS

FIG. 1 is a conceptual, top, plan view of a personnel locating system in a facility.

FIG. 2 is a schematic, block diagram of a receptacle according to one embodiment of the present invention, and associated components of a personnel locating system.

### DETAILED DESCRIPTION OF EMBODIMENTS OF THE INVENTION

The embodiments described below are merely exemplary and are not intended to limit the invention to the precise forms disclosed. Instead, the embodiments were selected for description to enable one of ordinary skill in the art to practice the invention.

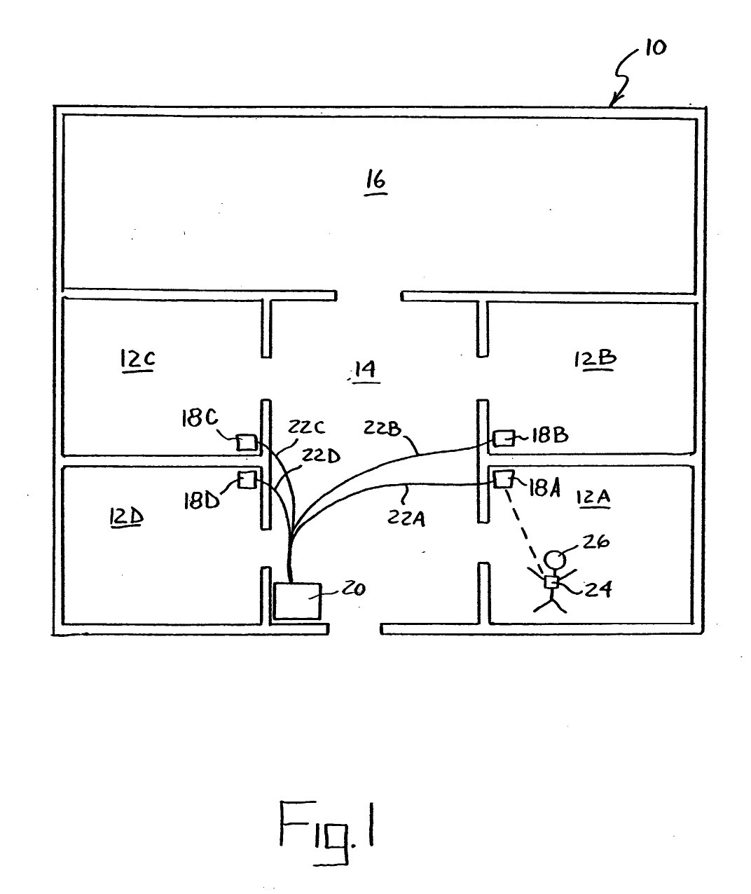

FIG. 1 shows an area or facility 10 having multiple locations or rooms 12A-D, a common area 14, and a remote area 16. As an example, facility 10 is described herein as a health care facility such as a hospital. It should be understood, however, that the present invention may be employed at any of a variety of different facilities that use personnel locating systems. In general, such personnel locating systems include a plurality of receivers 18A-D mounted at fixed locations throughout facility 10. In the example of FIG. 1, receivers 18A-D are mounted in rooms 12A-D, respectively. Of course, any number of receivers in a corresponding number of locations may be used.

Each of receivers 18A-D is connected to a central processor 20 positioned in an accessible location such that personnel may determine the location(s) of other personnel by viewing location information on a display (not shown) associated with central processor 20. Typically, central processor 20 receives information from receivers 18A-D and includes software for processing the information to determine the location of individuals in the system as is further described below. While receivers 18A-D are shown connected to central processor 20 by cable or wires 22A-D, any of a variety of known wireless communication techniques may be employed.

Personnel locating systems also include a plurality of badges 24 (only one shown in FIG. 1) worn by facility personnel, such as individual 26. Such personnel may include doctors, nurses, maintenance personnel, and other personnel who may need to be located quickly. It should further be understood that badges 24 (or similar devices) may be mounted on or connected to pieces of equipment or other objects which may be moved from location to location.

In operation, when individual 26 (wearing badge 24) enters room 12A, individual 26 is in close proximity to receiver 18A. Badge 24 includes a transmitter (not shown in FIG. 1) that periodically (and relatively frequently) transmits an identification signal (indicated in dotted lines). The identification signal is unique to badge 24, which in turn is assigned to or associated with individual 26. Receiver 18A receives the identification signal, and forwards it to central processor 20. Central processor 20 then determines from the identification signal and the fact that it was forwarded by receiver 18A, that individual 26 is located in room 12A according to principles known in the art. This information, as well as location information relating to other personnel, may be displayed on a monitor (not shown) associated with central processor 20. As individual 26 moves through rooms 12A-D, for example, receivers 18A-D receive the identification signal from badge 24 and forward that information to central processor 20, which updates the location information relating to individual 26.

It should be understood, however, that when individual 26 is out-of-range of all of receivers 18A-D, the location of individual 26 cannot be determined. This situation may occur, for example, when individual 26 leaves facility 10 or enters remote area 16 (for example, a parking area or supply storage area). During the time that individual 26 is out-of-range, it may not be possible to determine whether individual 26 is on-duty or off-duty. If individual 26 is off-duty, then any time and effort spent trying to determine the location of individual 26 is wasted.

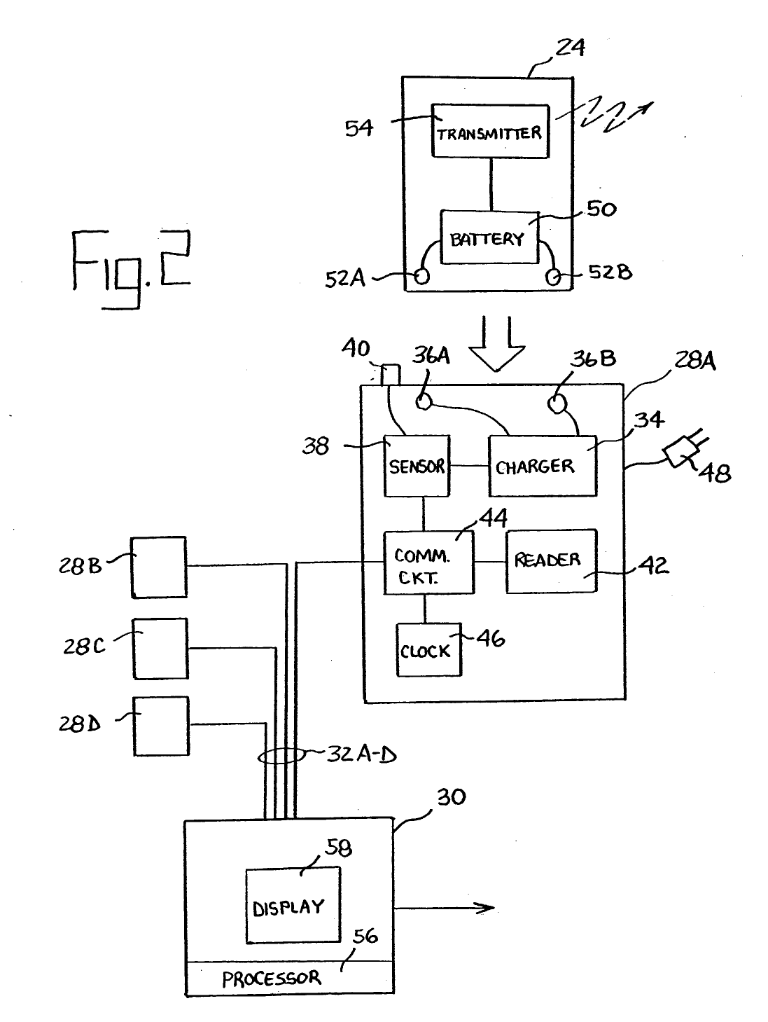

Referring now to FIG. 2, a system for determining whether an individual is within an area (such as facility 10) according to the present invention further includes a plurality of receptacles 28A-D connected, for example, to a monitor 30 by wires 32A-D, respectively. It should be understood that receptacles 28A-D may be connected instead to central computer 20, and the connections may be made by any of a variety of wireless communications techniques. In FIG. 2, only receptacle 28A is shown in detail. The remaining receptacles 28B-D are essentially identical to receptacle 28A. Also, any number of receptacles 28A-D greater or less than that shown in FIG. 2 may be implemented according to the teachings of the present invention. Each receptacle 28A-D may be placed in an accessible location, such as a nurse station, or some other relatively central location within the area of facility 10 serviced by the system.

Receptacle 28A includes a charger 34 connected to contacts 36A-B, a sensor 38, an indicator 40, a reader 42, a communications circuit 44, a clock 46 and an AC plug 48. Receptacle 28A further includes an area (not shown), for example a slot, for receiving badge 24 as is further described below. In fact, it is well within the ability of one of ordinary skill in the art to modify receptacle 28A to include a plurality of badge-receiving areas, each interfaced to the various components of receptacle 28A in the manner described below. In this manner, a single receptacle 28A can simultaneously recharge a plurality of badges 24 and provide “on-duty” or “off-duty” status information for the plurality of individuals 26 corresponding to the plurality of badges 24.

Badge 24 includes a rechargeable battery 50 that is connected to contacts 52A-B, and a transmitter 54. As described above, transmitter 54 periodically transmits an identification signal (indicated in dotted lines in FIG. 2). After a certain amount of use, however, the energy provided by battery 50 to transmitter 54 becomes insufficient to generate the identification signal. To avoid such insufficient charge conditions, and the associated inability to locate the individual assigned to badge 24, it is desirable to regularly and frequently recharge battery 50, such as at the end of each shift.

In operation, badge 24 is engaged with, inserted into, received by, or otherwise coupled to receptacle 28A such that contacts 52A-B contact contacts 36A-B, respectively. Receptacle 28A is connected through AC plug 48 to a power source (not shown), such as a wall outlet, to receive power to charge battery 50. Charger 34 charges battery 50 through contacts 36A-B in a conventional manner. In one embodiment of the invention, sensor 38 senses the level of charge in battery 50 and controls indicator 40 to indicate the charge status of battery 50. For example, sensor 38 may sense whether the charge of battery 50 has reached an acceptable threshold value. While battery 50 is charging, but its charge value is below the threshold, sensor 38 may generate a “charging” signal that causes indicator 40 to blink, indicating that battery 50 is being charged. When the charge value of battery 50 exceeds the threshold, sensor 38 may generate a “charge complete” signal that causes indicator 40 to shut off, indicating that battery 50 is no longer being charged.

Additionally, sensor 38 may readily be configured to monitor the elapsed charging time by, for example, receiving a clock signal from clock 46. Sensor 38 may further be configured indicate a fault (for example, a faulty charger 34 or battery 50) by, for example, generating a “cannot charge” signal that causes indicator 40 to light continuously if the charge value of battery 50 fails to exceed the threshold within a predetermined period of time as monitored by sensor 38.

While this specification describes indicator 40 as a light or LED, indicator 40 may also consist of an audio indicator with multiple states of activation corresponding to different battery charge conditions, an indicator with movable segments or components that change configuration based on the various battery charge conditions, or any other suitable indicator.

In addition to charging battery 50 when receptacle 28A receives badge 24, receptacle 28A also uses reader 42 to read the identification signal transmitted by transmitter 54. Reader 42 may include any suitable receiver circuitry to receive the identification signal. In one embodiment of the invention, reader 42 is only activated when a badge 24 is received by receptacle 28A so as to avoid reader 42 receiving identification signals from individuals passing near receptacle 28A. It should be understood that reader 42 (if configured to receive the identification signal via wireless communication technology) should also be configured to have a relatively short range of reception to avoid reading a nearby badge instead of the badge received by receptacle 28A. Of course, badge 24 and receptacle 28A may alternatively be configured to include additional contacts or conductors for communicating the identification signal from badge 24 to receptacle 28A via non-wireless technology.

When reader 42 receives the identification signal, reader 42 provides the associated information electronically to communication circuit 44. Communication circuit 44 sends a “not present” signal over wire 32A to monitor 30. It should be understood that instead of using reader 42 and communication circuit 44, receptacle 28A may readily be configured to include a transceiver which functions both to receive identification signals from badges 24 and to transmit the corresponding identification information (for example, in the form of a “not present” signal) to monitor 30.

Monitor 30 may include a processor 56 and a display 58. Processor 56 may be configured to operate software for processing the “not present” signals received from receptacles 28A-D to determine the identity of the individuals (if any) who have entered “off-duty” status by inserting their badges 24 into a receptacle 28A-D. The status information (i.e., “on-duty” or “off-duty”) may be displayed on display 58 in association with the name of the individual or other identifying information. As should be apparent from the foregoing, if central processor 20 is used as monitor 30 (or vice-versa), or if monitor 30 is in communication with central processor 20, both the location information and the status information for all personnel in the system may be simultaneously displayed.

Additionally, whenever communications circuit 44 sends a “not present” signal to monitor 30 (or stops providing such a signal when badge 24 is removed from receptacle 28A), communications circuit 44 may also access date and time information from clock 46 to provide a time-stamped “not present” signal to monitor 30. Consequently, monitor 30 may display the date and time of day when individual 26 associated with badge 24 inserted the badge 24 into receptacle 28A (thereby entering “off-duty” status) and the date and time of day individual 26 removed badge 24 from receptacle 28A to enter “on-duty” status. This information may be useful for payroll purposes, personnel management, workload planning, and a variety of other purposes. By tying hours reporting or a time-clock function to the act of placing badge 24 in receptacle 28A for recharging, the present invention encourages regular recharging, thereby decreasing the possibility that badge 24 will fail during use.

The foregoing description of the invention is illustrative only, and is not intended to limit the scope of the invention to the precise terms set forth. Although the invention has been described in detail with reference to certain illustrative embodiments, variations and modification exist within the scope and spirit of the invention as described and defined in the following claims.

What is claimed is:

1. A system for determining whether an individual is within an area, including:
a badge associated with the individual having a rechargeable battery and an identifier; and
a receptacle having a battery charger and a reader;
wherein when the badge is placed in the receptacle, the battery charger charges the badge battery and the reader reads the badge identifier, thereby indicating that the individual is not in the area.

2. The system of claim 1 further including a monitor coupled to the receptacle, the receptacle providing a “not present” signal to the monitor when the reader reads the badge identifier, the monitor displaying a message in response to a “not present” signal indicating that the individual is not present in the area.

3. The system of claim 2 wherein the receptacle provides a time stamp along with the “not present” signal indicating the date and time.

4. The system of claim 1 wherein the badge is worn by the individual.

5. The system of claim 1 wherein the identifier includes a transmitter for transmitting an identification signal.

6. The system of claim 5 wherein the reader includes a receiver for receiving the identification signal.

7. The system of claim 1 wherein the receptacle includes a charge sensor for measuring a charge of the battery, the sensor generating a first signal when the charge is greater than a threshold value, and a second signal when the charge is less than the threshold value.

8. The system of claim 7 wherein the receptacle includes an indicator for indicating the inability of the receptacle to charge the battery, the receptacle activating the indicator if, after charging the battery for a predetermined period of time, the sensor generates the second signal.

9. For use in a facility having a personnel locating system wherein personnel wear badges, powered by rechargeable batteries, that transmit identification signals to receivers within the facility such that the location of the personnel can be determined, a method for encouraging personnel to recharge the battery of their respective badge including the steps of:
providing a receptacle having a battery charger;
charging the battery of a badge when the badge is coupled to the receptacle;
reading the identification signal from the badge; and
recording the date and time when the badge is coupled to the receptacle.

10. The method of claim 9 further including the steps of:
providing a monitor coupled to the receptacle; and
displaying a message after reading the identification signal indicating that an individual associated with the badge is not present in the facility.

11. The method of claim 9 wherein the step of charging the battery includes the step of sensing a charge of the battery.

12. The method of claim 11 wherein the step of sensing the charge of the battery includes the step of indicating the inability of the battery charger to properly charge the battery.

13. A system for locating personnel within a facility, including:
a plurality of badges, each badge being associated with a particular individual and including a rechargeable battery and a transmitter for transmitting an identification signal unique to the badge;
a plurality of receivers positioned in the facility for receiving identification signals from badges in proximity to the receivers;
a central processor coupled to the plurality of receivers for reading the identification signals from the receivers to determine the locations of the individuals associated with the badges in proximity to the receivers; and
a receptacle for receiving a badge when an individual associated with the badge is off-duty, the receptacle having a battery charger for recharging a battery of the received badge and a reader for receiving the identification signal from the received badge, thereby indicating that the individual associated with the received badge is off-duty.

14. The system of claim 13 further including a monitor coupled to the receptacle, the receptacle providing a “not present” signal to the monitor when the receptacle reader receives the identification signal, the monitor displaying a message in response to a “not present” signal indicating that the individual associated with the received badge is off-duty.

15. The system of claim 14 wherein the receptacle provides a time stamp along with the “not present” signal indicating the date and time.

16. The system of claim 13 wherein the receptacle includes a charge sensor for measuring a charge of the battery of the received badge, the sensor generating a first signal when the charge is greater than a threshold value, and a second signal when the charge is less than the threshold value.

17. The system of claim 16 wherein the receptacle includes an indicator for indicating the inability of the receptacle to charge the battery of the received badge, the receptacle activating the indicator if, after charging the battery for a predetermined period of time, the sensor generates the second signal.

18. A system for determining whether an individual is within an area, including:
a badge associated with the individual having rechargeable battery means for powering the badge and means for providing an indicator to identify the badge; and
means for receiving the badge when the badge is not in use, the receiving means including means for charging the rechargeable battery means and means for reading the indicator;
wherein when the badge is placed in the receiving means, the charging means charges the rechargeable battery means and the reading means reads the indicator, thereby indicating that the individual is not in the area.

19. The system of claim 18 further including means for monitoring the receiving means, the receiving means providing a “not present” signal to the monitoring means when the reading means reads the indicator, the monitoring means displaying a message in response to a “not present” signal indicating that the individual is not present in the area.

20. The system of claim 18 wherein the means for providing an indicator includes means for transmitting an identification signal.

21. The system of claim 20 wherein the reading means includes means for receiving the identification signal.

22. The system of claim 18 wherein the receiving means includes means for sensing a charge of the rechargeable battery means, the sensing means generating a first signal when the charge is greater than a threshold value, and a second signal when the charge is less than the threshold value.

23. The system of claim 22 wherein the receiving means includes means for indicating that the charging means is unable to properly charge the rechargeable battery means, the receiving means activating the indicating means if, after charging the battery for a predetermined period of time, the sensing means generates the second signal.
